(19) United States
(12) Patent Application Publication
(10) Pub. No.: US 2022/0183924 A1
(43) Pub. Date: Jun. 16, 2022

(54) Portable Massage Ball Assembly

(71) Applicant: Casey Howard, Gilbert, AZ (US)

(72) Inventor: Casey Howard, Gilbert, AZ (US)

(21) Appl. No.: 17/122,498

(22) Filed: Dec. 15, 2020

(51) Int. Cl. A61H 15/00

(52) U.S. Cl. CPC A61H 15/00; A61H 2015/0064; A61H 2201/0157; A61H 2201/0192; A61H 2203/0431; A61H 2201/0119

(57) ABSTRACT

A portable massage ball assembly for facilitating a user to massage their back while seated in a vehicle includes a clasp that is closable around a support such that the clasp can be attached to a seat in a vehicle. A retractor is coupled to the clasp and a cable is integrated into the retractor. Additionally, the cable is drawable outwardly from the retractor. A ball is coupled to the cable such that the ball can be positioned between the seat in the vehicle and a user. In this way the user can massage their back with the ball.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to massage devices and more particularly pertains to a new massage device for facilitating a user to massage their back while seated in a vehicle.

### (2) Description of Related Art Including Information Disclosed Under 37 CFR 1.97 and 1.98

The prior art relates to massage devices including a variety of hand held massaging devices that includes a ball. The prior art discloses a variety of massage ball devices that includes a clasp and a line for suspending a massage ball from a support. The prior art also discloses a variety of massage devices that include a ball and a cord that can be tied around a support for massaging a user. Additionally, the prior art discloses a variety of massage devices that include a ball and a cord that can be tied to a user's body for massaging the user's body.

### BRIEF SUMMARY OF THE INVENTION

An embodiment of the disclosure meets the needs presented above by generally comprising a clasp that is closable around a support such that the clasp can be attached to a seat in a vehicle. A retractor is coupled to the clasp and a cable is integrated into the retractor. Additionally, the cable is drawable outwardly from the retractor. A ball is coupled to the cable such that the ball can be positioned between the seat in the vehicle and a user. In this way the user can massage their back with the ball.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a portable massage ball assembly according to an embodiment of the disclosure.

FIG. 2 is a front phantom view of an embodiment of the disclosure.

FIG. 3 is a perspective in-use view of an embodiment of the disclosure.

FIG. 4 is a perspective view of an alternative embodiment of the disclosure.

### DETAILED DESCRIPTION OF THE INVENTION

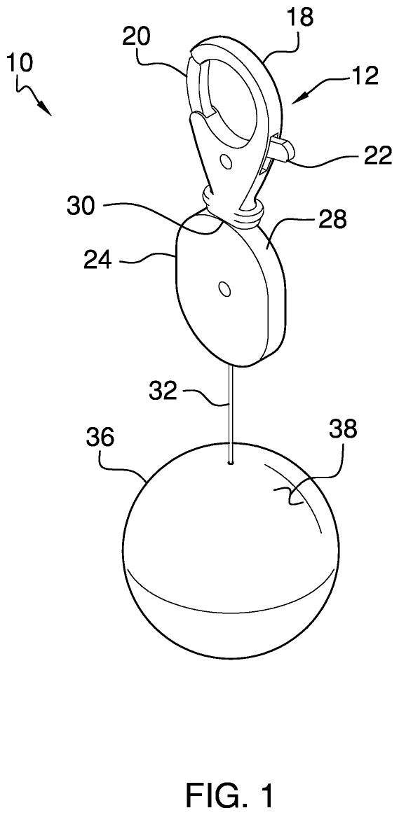

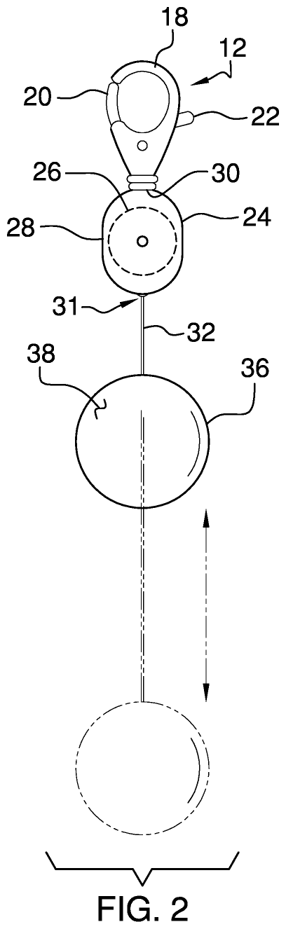

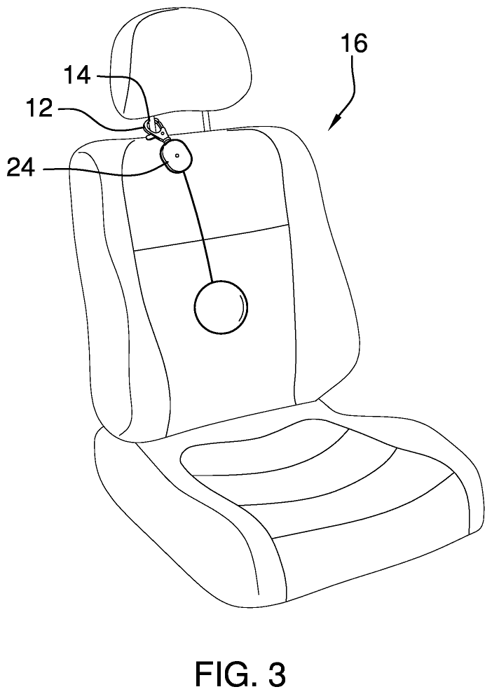

With reference now to the drawings, and in particular to FIGS. 1 through 4 thereof, a new massage device embodying the principles and concepts of an embodiment of the disclosure and generally designated by the reference numeral 10 will be described.

As best illustrated in FIGS. 1 through 4, the portable massage ball assembly 10 generally comprises a clasp 12 that is closable around a support 14 thereby facilitating the clasp 12 to be attached to a seat 16 in a vehicle. The support 14 may be a rod on a head rest of the seat 16 or other type of stanchion. The vehicle may be a passenger vehicle, a cargo vehicle or any other type of motorized vehicle that is driven on public roadways. The clasp 12 includes a curved member 18 and a jaw 20 that is pivotally integrated into the curved member 18.

The jaw 20 is positionable in a closed position such that the curved member 18 and the jaw 20 form a closed loop. Conversely, the jaw 20 is positionable in an open position having the jaw 20 angling away from the curved member 18 thereby facilitating the curved member 18 to be positioned around the support 14. The jaw 20 is biased into the closed position and the clasp 12 includes a lever 22 that is movably integrated therein such that the lever 22 can be manipulated by a user. Moreover, the lever 22 is in mechanical communication with the jaw 20 thereby facilitating the lever 22 to urge the jaw 20 into the open position when the lever 22 is manipulated. The clasp 12 may comprise a lobster claw clasp or other similar type of mechanical clasp.

A retractor 24 is provided and the retractor 24 is coupled to the clasp 12. The retractor 24 includes a spool 26 that is rotatably positioned therein. The spool 26 is rotatable in a first direction and the spool 26 is biased to rotate in a second direction. The retractor 24 has an outer wall 28 and the outer wall 28 is coupled to a bottom end 30 of the clasp 12. The outer wall 28 has an opening 31 extending into an interior of the retractor 24 and the opening 31 is positioned on an opposite end of the outer wall 28 with respect to the bottom end 30 of the clasp 12. The spool 26 may be a spring loaded spool that can engage a respective stop for retaining the spool 26 at a selected degree of rotation in the retractor 24. Additionally, the spool 26 may be disengaged from the respective stop to facilitate the spool 26 to rotate in the second direction.

A cable 32 is integrated into the retractor 24 and the cable 32 is drawable outwardly from the retractor 24. The cable 32 is wrapped around the spool 26 and the cable 32 extends outwardly through the opening 31 in the outer wall 28 of the retractor 24. The spool 26 rotates in the first direction when the cable 32 is drawn outwardly from the retractor 24 and the cable 32 has a distal end 34 with respect to the retractor 24. A ball 36 is coupled to the cable 32 such that the ball 36 can be positioned between the seat 16 in the vehicle and a user thereby facilitating the user to massage their back with the ball 36. The ball 36 has an outer surface 38 and the outer surface 38 is attached to the distal end 34 of the cable 32. Additionally, the ball 36 is comprised of a resiliently compressible material thereby facilitating the ball 36 to enhance comfort for the user.

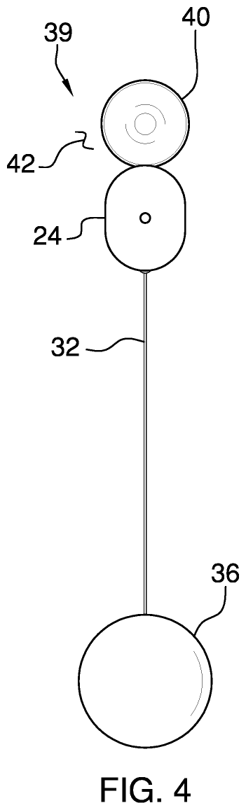

In an alternative embodiment 39 as is most clearly shown in FIG. 4, a suction cup 40 is provided that is compressible against a support surface 42 such that the suction cup 40 suctionally engages the support surface 42. The support surface 42 may be a window, a wall or other smooth, vertical support surface. The suction cup 40 is disposed on the outer wall 28 of the retractor 24 thereby facilitating the ball 36 to be suspended from the suction cup 40.

In use, the clasp 12 is coupled to the support 14 and the ball 36 is drawn downwardly from the retractor 24 a selected distance such that the ball 36 rests against a backrest 44 of the seat 16. In this way the ball 36 can be aligned with a chosen location on the user's back or neck. Thus, the user can massage their back or neck while the user is driving or riding in the vehicle. In this way the user can gain relief from muscle tension and knots while the user is seated in the vehicle. The ball 36 can be pulled downwardly from the retractor 24 to release the spool 26 such that the spool 26 retracts the ball 36 against the retractor 24 for storage.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable massage ball assembly for being suspended from a support thereby facilitating a user to press their body thereagainst for the purposes of massage, said assembly comprising:
a clasp being closable around a support wherein said clasp is configured to be attached to a seat in a vehicle;
a retractor being coupled to said clasp;
a cable being integrated into said retractor, said cable being drawable outwardly from said retractor; and
a ball being coupled to said cable wherein said ball is configured to be positioned between the seat in the vehicle and a user thereby facilitating the user to massage their back with said ball.

2. The assembly according to claim 1, wherein said clasp includes a curved member and a jaw being pivotally integrated into said curved member, said jaw being positionable in a closed position such that said curved member and said jaw form a closed loop, said jaw being positionable in an open position having said jaw angling away from said curved member thereby facilitating said curved member to be positioned around the support, said jaw being biased into said closed position.

3. The assembly according to claim 2, wherein said clasp includes a lever being movably integrated therein wherein said lever is configured to be manipulated by a user, said lever being in mechanical communication with said jaw thereby facilitating said lever to urge said jaw into said open position when said lever is manipulated.

4. The assembly according to claim 1, wherein said retractor includes a spool being rotatably positioned therein, said spool being rotatable in a first direction, said spool being biased to rotate in a second direction, said retractor having an outer wall, said outer wall being coupled to a bottom end of said clasp, said outer wall having an opening extending into an interior of said retractor.

5. The assembly according to claim 4, wherein said cable is wrapped around said spool, said cable extending outwardly through said opening in said outer wall, said spool rotating in said first direction when said cable is drawn outwardly from said retractor, said cable having a distal end with respect to said retractor.

6. The assembly according to claim 5, wherein said ball has an outer surface, said outer surface being attached to said distal end of said cable, said ball being comprised of a resiliently compressible material wherein said ball is configured to enhance comfort for the user.

7. A portable massage ball assembly for being suspended from a support thereby facilitating a user to press their body thereagainst for the purposes of massage, said assembly comprising:
a clasp being closable around a support wherein said clasp is configured to be attached to a seat in a vehicle, said clasp including a curved member and a jaw being pivotally integrated into said curved member, said jaw being positionable in a closed position such that said curved member and said jaw form a closed loop, said jaw being positionable in an open position having said jaw angling away from said curved member thereby facilitating said curved member to be positioned around the support, said jaw being biased into said closed position, said clasp including an lever being movably integrated therein wherein said lever is configured to be manipulated by a user, said lever being in mechanical communication with said jaw thereby facilitating said lever to urge said jaw into said open position when said lever is manipulated;
a retractor being coupled to said clasp, said retractor including a spool being rotatably positioned therein, said spool being rotatable in a first direction, said spool being biased to rotate in a second direction, said retractor having an outer wall, said outer wall being coupled to a bottom end of said clasp, said outer wall having an opening extending into an interior of said retractor;
a cable being integrated into said retractor, said cable being drawable outwardly from said retractor, said cable being wrapped around said spool, said cable extending outwardly through said opening in said outer wall, said spool rotating in said first direction when said cable is drawn outwardly from said retractor, said cable having a distal end with respect to said retractor; and
a ball being coupled to said cable wherein said ball is configured to be positioned between the seat in the vehicle and a user thereby facilitating the user to massage their back with said ball, said ball having an outer surface, said outer surface being attached to said distal end of said cable, said ball being comprised of a resiliently compressible material wherein said ball is configured to enhance comfort for the user.

8. The assembly according to claim 7, further comprising a suction cup being compressible against a support surface wherein said suction cup is configured to suctionally engage the support surface, said suction cup being disposed on said outer wall of said retractor thereby facilitating said ball to be suspended from said suction cup.
